(19) United States
(12) Patent Application Publication
(10) Pub. No.: US 2019/0291599 A1
(43) Pub. Date: Sep. 26, 2019

(54) Electric Power Supply Device And Flying Machine Using The Electric Power Supply Device

(71) Applicant: DENSO CORPORATION, Kariya-city (JP)

(72) Inventors: Shinji ANDOU, Nisshin-city (JP); Satoru YOSHIKAWA, Nisshin-city (JP); Tetsuji MITSUDA, Kariya-city (JP)

(21) Appl. No.: 16/297,881

(22) Filed: Mar. 11, 2019

(30) Foreign Application Priority Data
Mar. 22, 2018 (JP) 2018-54516

(51) Int. Cl. B60L 53/24; H02J 7/00; H02J 7/14; B64C 39/02; G05D 1/00; B60L 50/10; B60L 50/50

(52) U.S. Cl. CPC B60L 53/24; H02J 7/0068; H02J 7/1469; B64C 39/024; B60L 2200/10; B60L 50/10; B60L 50/50; B64C 2201/042; B64C 2201/066; G05D 1/0011

(57) ABSTRACT

An electric power supply apparatus includes a first power supply unit, a second power supply unit, diodes, detection units, and an electric power control unit. The first power supply unit and the second power supply unit supply electric power to a thruster which is a load. The diodes are provided in the first power supply unit and the second power supply unit, respectively, to restrict reverse flow of currents to the power supply units. The detection units are provided between the first power supply unit and the thruster and between the second power supply unit and the thruster, respectively, to detect at least one of a voltage and a current. The electric power control unit controls electric power transmission between the first power supply unit and the second power supply unit based on detection values of the detection units.

### CROSS REFERENCE TO RELATED APPLICATION

The present application is based on Japanese patent application No. 2018-54516 filed on Mar. 22, 2018 the whole contents of which are incorporated herein by reference.

### FIELD

The present disclosure relates to an electric power supply device and a flying machine using the electric power supply device.

### BACKGROUND

There are two electric power supply devices, which supply electric power to a load. One is a base electric power supply device for supplying stabilized electric power as base electric power and the other is am electric power supply device for supplying a relatively large electric power instantaneously when needed. In patent document JP 60160411 (JP 2016-147519A), for example, a flying machine called a drone uses a fuel cell as the base electric power supply device and a secondary battery such as a lithium-ion battery for momentary electric power supply. The fuel cell has a large electric power capacity in comparison to a general secondary battery and is superior in supplying electric power for a long period. On the other hand, the secondary battery is superior in supplying a large electric power instantaneously in comparison to the fuel cell.

However, since electric power capacity of the secondary battery such as a lithium-ion battery is small, the secondary battery tends to lose electric power earlier than the fuel cell even in case it is used in limited application. For this reason, in the patent document referred to above, the electric power capacity of the secondary battery limits electric power supply ability of a whole electric power supply device and makes it difficult to supply electric power stably for a long period.

### SUMMARY

It is therefore an object of the present disclosure to provide an electric power supply device which attains stable electric power supply for a long period by controlling mutual electric power transmission among multiple electric power supply devices by using voltages and currents of the multiple electric power supply devices, and a flying machine which uses the electric power supply device.

According to one aspect of the present disclosure, a power supply device includes detection units. Detection units are provided between multiple power supply units of the power supply device and a load and detect at least one of voltage and current of electric power supplied from the multiple power supply units to the load, respectively. A power control unit controls transmission of electric power between the multiple power supply units based on the voltage or current detected by the detection units. That is, when the voltage of one of the multiple power supply units drops, the power control unit supplies electric power from the other power supply unit. As a result, the power supply unit a power supply voltage of which is lowered is charged with electric power supplied from another power supply unit. As a result, even in case that a power capacity of one of the multiple power supply units is small, the power supply unit having low power capacity is charged by another power supply unit having a large power supply margin. Therefore, it is possible to supply electric power stably for a long period.

According to another aspect of the present disclosure, a flying machine includes the power supply device. The flying machine requires instantaneous large electric power when it need be controlled with high responsiveness to disturbance such as flight at high speed and wind. Except for such cases as high-speed flight control and anti-disturbance flight control, the flying machine can maintain flight with the power supply from a base power supply unit like a fuel cell of the power supply device. In addition, the base power supply unit for maintaining the flight of the flying machine has sufficient margin in power supply. Therefore, when the flying machine is flying only with the basic supply power, for example, during hovering, the base power supply unit can supply electric power to a power supply unit which needs to supply the instantaneous power. The power control unit charges the power supply unit which supplies the instantaneous power from the base power supply unit when the flying machine is flying with the electric power from the base power supply unit. As a result, even when the power capacity of the power supply unit required to supply the instantaneous power is small, the power supply unit can maintain its electric power supply owing to charging by the base power supply unit as long as the base power supply unit is capable of supplying the electric power.

### BRIEF DESCRIPTION OF THE DRAWINGS

FIG. 1 is a schematic block diagram showing an electric power supply device according to a first embodiment;

FIG. 2 is a schematic block diagram showing a flying machine including the electric power supply device according to the first embodiment;

FIG. 3 is a schematic plan view showing a planar shape of the flying machine according to the first embodiment;

FIG. 4 is a schematic side view taken in an arrow direction IV in FIG. 3;

FIG. 5 is a flowchart showing power supply control processing of the flying machine according to the first embodiment;

FIG. 6 is a schematic block diagram showing a flying machine according to a second embodiment; and

FIG. 7 is a schematic block diagram showing a flying machine according to a further embodiment.

### DETAILED DESCRIPTION OF THE EMBODIMENT

A flying machine using an electric power supply device will be described with reference to multiple embodiments shown in the accompanying drawings. In the multiple embodiments, substantially the same structural parts are designated with the same reference numerals thereby simplifying the description.

### First Embodiment

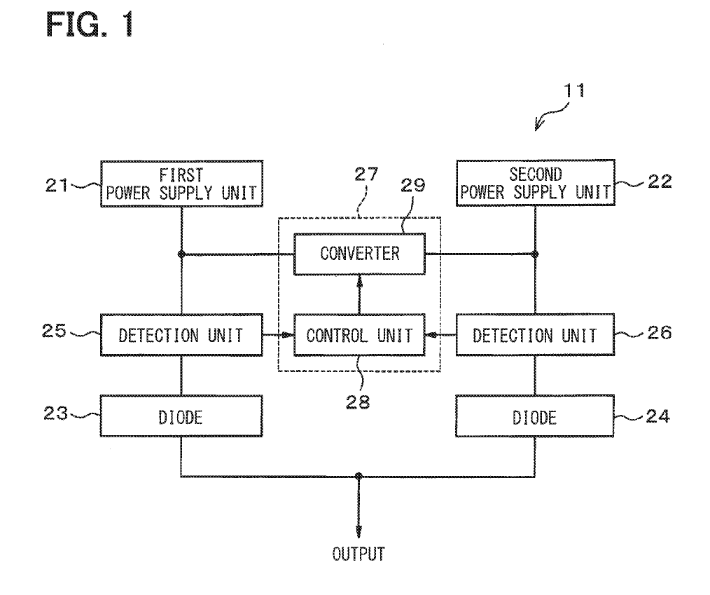

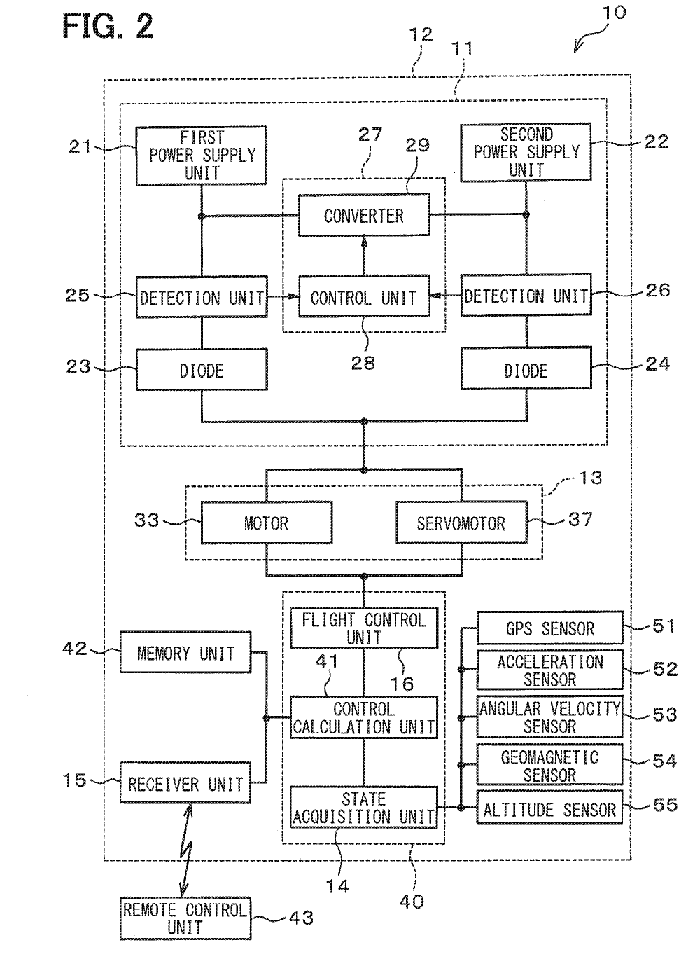

A flying machine 10 according to a first embodiment is shown in FIG. 1 to FIG. 5. As shown in FIG. 2, in particular, the flying machine 10 includes an electric power supply device 11, a base body 12, a thruster 13, a state acquisition unit 14, a receiver unit 15 and a flight control unit 16. As shown in FIG. 1 and FIG. 2, the electric power supply device 11 includes a first power supply unit 21, a second power supply unit 22, first and second diodes 23 and 24, first and second detection units 25 and 26, and an electric power control unit 27. The first power supply unit 21 is one of electric power supply devices used for flying of the base body 12. Specifically, the first power supply unit 21 is a power supply unit which is capable of supplying the base body 12 with electric power with high responsiveness when the electric power is needed instantaneously. Therefore, the first power supply unit 21 includes a power supply unit such as a lithium-ion battery, for example, which has high responsiveness and is capable of charging and discharging repeatedly. A secondary battery like a lithium-ion battery and a nickel-hydrogen battery is capable of repeated charging and discharging and highly responsive to supply of electric power. For this reason, the first power supply unit 21 including the secondary battery is suitable as an auxiliary battery for the base body 12. That is, the first power supply unit 21 supplies electric power to the base body 12 when large electric power is needed in a short period in such instances where the base body 12 need be controlled with high responsiveness relative to disturbance like wind or the base body 12 flies at high speeds.

The second power supply unit 22 is one of base power supply unit used for the flight of the base body 12. Specifically, the second power supply unit 22 is a power supply unit which is capable of supplying the base body 12 with electric power for a long period. The second power supply unit 22 includes, for example, an electric power source such as a fuel cell and an engine-generator which generate electric power, or a battery or capacitor having a large electric power capacity. The fuel cell is capable of generating a large electric power stably for a long period. For this reason, the second power supply unit 22 including the fuel cell is suitable as a base power supply unit for the base body 12. The engine-generator may use a gasoline engine, a diesel engine or a gas turbine engine. The engine-generator of this kind is relatively heavy-weighted but capable of generating large electric power for a long period stably. Particularly the gas turbine is not so heavy-weighted but is capable of generating large electric power. For this reason, the second power supply unit 22 including the engine-generator is also suitable as a base power supply unit for the base body 12. The second power supply unit 22 supplies the base electric power to the base body 12 when the base body 12 flies stably like hovering, for example.

The diode 23 is provided between the first power supply unit 21 and the load which consumes the electric power of the electric power supply device 11. In the first embodiment, the diode 23 is provided between the first power supply unit 21 and the thruster 13 which is the load as shown in FIG. 2. The diode 24 is provided between the second power supply unit 22 and the load. In the second embodiment, the diode 24 is provided between the second power supply unit 22 and the thruster 13 which is the load. These diode 23 and diode 24 both prevent currents from flowing reversely therethrough. That is, the diode 23 prevents the current flowing in reverse from the thruster 13 side which is the load to the first power supply unit 21. Similarly, the diode 24 prevents the current flowing in reverse from the thruster 13 side which is the load to the second power supply unit 22.

The detection unit 25 is provided between the diode 23 and the first power supply unit 21. Further, the detection unit 26 is provided between the diode 24 and the second power supply unit 22. The detection unit 25 and the detection unit 26 both detect either one of voltage and current. Specifically, the detection unit 25 detects the voltage between the first power supply unit 21 and the diode 23 or the current flowing between the first power supply unit 21 and the diode 23. Similarly, the detection unit 26 detects the voltage between the second power supply unit 22 and the diode 24 or the current flowing between the second power supply unit 22 and the diode 24. The detection unit 25 and the detection unit 26 may be configured to detect either one of the voltage and the current as a detection value or both of the voltage and the current as detection values.

In case of the electric power supply device 11 according to the first embodiment, the voltage of the first power supply unit 21 is set to be lower than that of the second power supply unit 22 when the electric power consumed by the load is small. That is, when the electric power consumed by the load is smaller than a predetermined threshold electric power, the voltage of the first power supply unit 21 is lower than that of the second power supply unit 22. As a result, when the electric power consumed by the load is small, the load is supplied with electric power from the second power supply unit 22. On the other hand, the voltage of the first power supply unit 21 is set to be higher than that of the second power supply unit 22 when the electric power consumed by the load increases. That is, the number of cells of the secondary battery forming the first power supply unit 21 is set such that the voltage of the first power supply unit 21 exceeds the voltage of the second power supply unit 22 when the electric power consumed by the load increases. As a result, when the electric power consumed by the load increases, the load is supplied with electric power from the first power supply unit 21.

The electric power control unit 27 includes a control unit 28 and a converter 29. The electric power control unit 27 controls transmission of electric power between the first power supply unit 21 and the second power supply unit 22 based on the detection values outputted by the detection unit 25 and the detection unit 26. The control unit 28 is formed of a microcomputer having a CPU, a ROM, a RAM, and the like. The control unit 28 controls the converter 29 by executing a computer program stored in the ROM. Thus, the control unit 28 controls the transmission of electric power between the first power supply unit 21 and the second power supply unit 22. The converter 29 has, for example, a transformer such as a DC/DC converter, a rectifier and the like. Based on the detection value detected by the detection unit 25 and the detection value detected by the detection unit 26, the control unit 28 turns on the converter 29 when the voltage of the first power supply unit 21 is lower than that of the voltage of the second power supply unit 22 and the first power supply unit 21 does not supply electric power. As a result, the electric power generated by the second power supply unit 22 is supplied to the first power supply unit 21 through the converter 29. As a result, the first power supply unit 21 is charged with electric power generated by the second power supply unit 22.

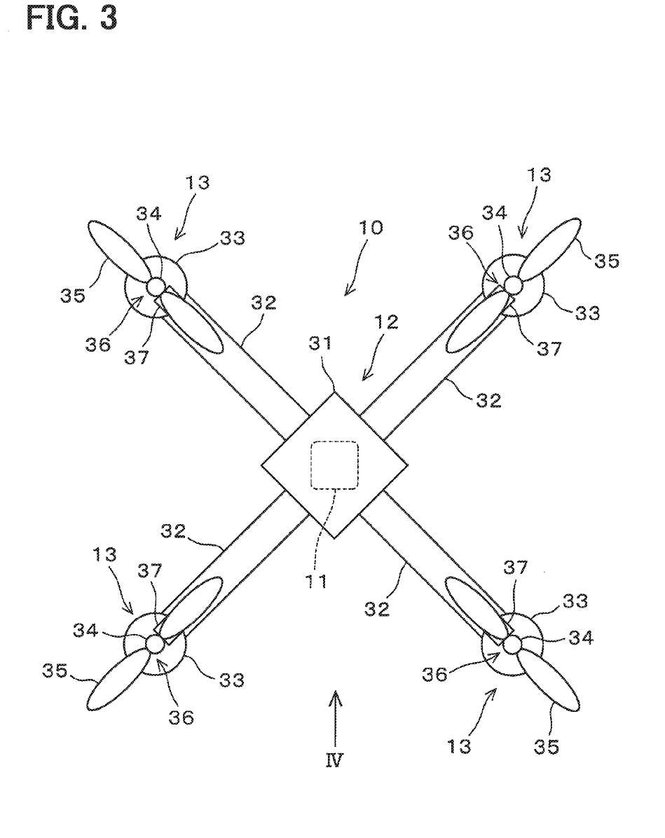

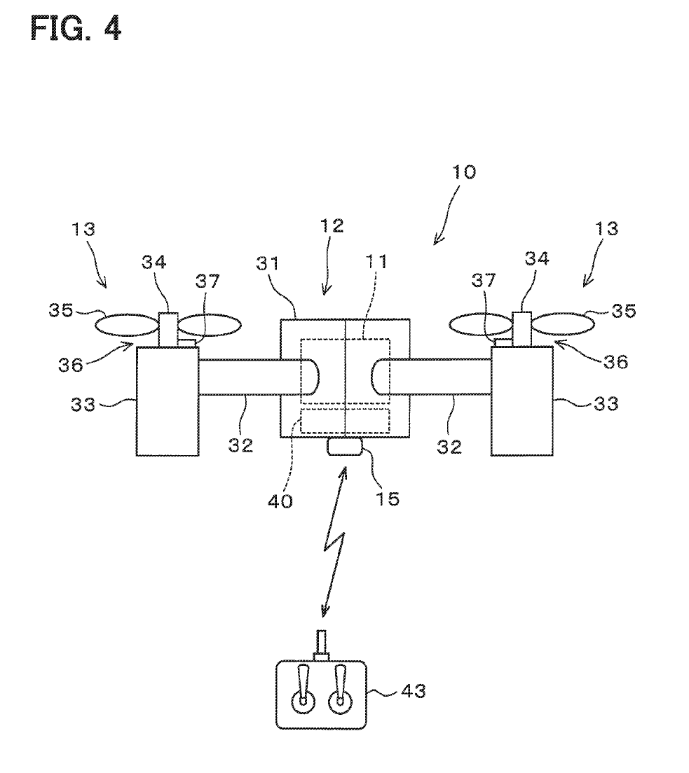

The flying machine 10 including the electric power supply device 11 configured as described above will be described below. The flying machine 10 further includes the base body 12, the thruster 13, the state acquisition unit 14, the receiver 15 and the flight control unit 16 in addition to the electric power supply device 11. As shown in FIG. 3 and FIG. 4, the base body 12 has a main body 31 and an arm 32. The main body 31 is provided at or near the center of gravity of the base body 12. The arm 32 is formed of multiple arm members extending radially from the main body 31. The thruster 13 is formed of multiple thruster members each of which is provided at a top end of each arm member of the arm 32. The base body 12 is not limited to a configuration in which the arm member extend radially from the main body 31 but may be in an arbitrary configuration different from the above-described configuration. For example, the base body 12 may be in an annular shape in which multiple thruster members of the thruster 13 are provided in a peripheral direction. The number of thruster members of the thruster 13 and the arm members of the arm 32 may be an arbitrary number, that is, 2 or more.

The thruster 13 is the load which receives electric power from the electric power supply device 11. Each thruster member of the thruster 13 includes a motor 33, a shaft 34 and a propeller 35. The motor 33 is a driving source for driving the propeller 35. The motor 33 is driven with the electric power supplied from the electric power supply device 11. Rotation of the motor 33 is transmitted to the propeller 35 through the shaft 34 which is integral with a rotor of the motor 33. The propeller 35 is rotationally driven by the motor 33. The thruster member may include a pitch changing mechanism 36. The pitch changing mechanism 36 is provided in each thruster member. The pitch changing mechanism 36 changes a pitch of the propeller 35 by driving force generated by a servomotor 37. The servomotor 37 is driven with electric power supplied from the electric power supply device 11. The thruster 13 generates thrust by driving the propeller 35 by the motor 33. The magnitude and direction of thrust generated by the thruster 13 is controlled by changing the rotation speed of the motor 33 and the pitch of the propeller 35.

The flying machine 10 includes a control unit 40 as shown in FIG. 2. The control unit 40 includes a control calculation unit 41 and a memory unit 42. The control calculation unit 41 is formed of a microcomputer having a CPU, a ROM and a RAM. The control calculation unit 41 controls a whole part of the base body 12 by executing a computer program stored in the ROM by the CPU. The control calculation unit 41 realizes the state acquisition unit 14 and the flight control unit 16 in a software manner by execution of the computer program although the state acquisition unit 14 and the flight control unit 16 are shown as separate units from the control calculation unit 41 in FIG. 2. The state acquisition unit 14 and the flight control unit 16 are not limited to software but may be realized by hardware or by cooperation between software and hardware. Further, the control unit 40 may be shared with the electric power control unit 27 of the electric power supply device 11.

The memory unit 42 includes, for example, a nonvolatile memory and the like. The memory unit 42 stores a preset flight plan as data. The flight plan includes a flight route and a flight altitude which the base body 12 flies. As shown in FIG. 2 and FIG. 4, the receiver 15 communicates with a remote control device 43 provided separately and away from the base body 12 by wireless or wired communication. The receiver unit 15 receives a signal transmitted from the remote control device 43.

The state acquisition unit 14 acquires a flight state of the base body 12 such as tilt of the base body 12, acceleration applied to the base body 12 and the like. More specifically, the state acquisition unit 14 is connected to a GPS sensor 51, an acceleration sensor 52, an angular velocity sensor 53, a geomagnetic sensor 54, an altitude sensor 55 and the like. The GPS sensor 51 receives GPS signals outputted from GPS satellites. The acceleration sensor 52 detects accelerations applied to the base body 12 in three axial directions of three dimensions. The angular velocity sensor 53 detects angular velocities applied to the base body 12 in three axial directions of three dimensions. The geomagnetic sensor 54 detects geomagnetism in three axial directions of three dimensions. The altitude sensor 55 detects an altitude in a vertical direction.

The state acquisition unit 14 acquires the GPS signals received by the GPS sensor 51, the acceleration detected by the acceleration sensor 52, the angular velocity detected by the angular velocity sensor 53, the geomagnetism detected by the geomagnetic sensor 54 and the like and determines a flight attitude, flight direction and flight speed. Further, the state acquisition unit 14 detects a flight position of the base body 12 from the GPS signals detected by the GPS sensor 51 and the detection values of various sensors. Further, the state acquisition unit 14 detects the flight altitude of the base body 12 from the altitude detected by the altitude sensor 55. In this manner, the state acquisition unit 14 detects, as a flight state, information such as the flight attitude, flight speed, flight position and flight altitude of the base body 12 necessary for flight of the base body 12. In addition to these, the state acquisition unit 14 may further be connected to a camera (not shown) which acquires a visible image or a light detection and ranging device (LIDAR, not shown) which measures a distance to surrounding objects.

The flight control unit 16 controls flight of the base body 12 in an automatic control mode or a manual control mode. The automatic control mode is a flight mode in which the base body 12 automatically flies without depending on manipulation by an operator. In the automatic control mode, the flight control unit 16 automatically controls the flight of the base body 12 according to the flight plan stored in the memory unit 42. That is, in the automatic control mode, the flight control unit 16 controls the thrust force of the thruster 13 based on the flight state of the base body 12 detected by the state acquisition unit 14 and the like. As a result, the flight control unit 16 causes the base body 12 to automatically fly in accordance with the flight plan without depending on the manipulation by the operator. On the other hand, the manual control mode is a flight mode in which the base body 12 is made to fly according to the manipulation of the operator. In the manual control mode, the operator controls the flight state of the base body 12 using the remote control device 43 provided separately and remotely from the base body 12. The flight control unit 16 controls the thrust force of the thruster 13 based on the manipulation inputted from the remote control device 43 and the flight state acquired by the state acquisition unit 14. As a result, the flight control unit 16 controls the flight of the base body 12 according to the intention of the operator.

In case that the electric power supply device 11 is applied to the flying machine 10, the electric power supply device 11 supplies electric power from either the first power supply unit 21 or the second power supply unit 22 according to the flight state of the base body 12. For example, when the base body 12 is stably flying, such as hovering or constant speed flight, the electric power supply device 11 supplies electric power from the second power supply unit 22 to the base body 12. When the consumption of electric power in the base body 12 is small as described above, the voltage of the second power supply unit 22 becomes higher than the voltage of the first power supply unit 21. Therefore, the thruster 13 of the base body 12 is supplied with electric power from the second power supply unit 22, the voltage of which is high. On the other hand, when a rapid change or movement of the flight attitude of the base body 12 is required, for example, because of disturbance such as wind, movement at high speed or emergency such as trouble, the electric power supply device 11 starts to supply electric power from the first power supply unit 21 to the base body 12. When the consumption of electric power in the base body 12 is large as described above, the voltage of the second power supply unit 22 becomes lower than the voltage of the first power supply unit 21. Therefore, the thruster 13 is supplied with electric power from the first power supply unit 21, the voltage of which is high. When the electric power consumption of the base body 12 is small, that is, the voltage of the first power supply unit 21 is low and the first power supply unit 21 does not supply electric power to the base body 12, the electric power control unit 27 of the electric power supply device 11 turns on the converter 29. When the converter 29 is turned on, electric power is supplied from the second power supply unit 22 of the high voltage to the first power supply unit 21 of the low voltage. As a result, the first power supply unit 21 is charged.

It is noted that, in case of the electric power supply device 11 according to the first embodiment, the second power supply unit 22 supplies the electric power for charging the first power supply unit 21 when the electric power consumed by the base body 12 is small, for example, during hovering. Therefore, it is preferable that the second power supply unit 22 has an electric power generation capacity of, for example, about 1.1 times the base supply power. The base supply power is electric power required for the base body 12 to maintain stable steady flight of the base body 12, for example, during hovering. By setting the electric power generation capacity of the second power supply unit 22 to about 1.1 times the base supply power, the second power supply unit 22 does not increase in size and increase in weight. Also, when the second power supply unit 22 charges the first power supply unit 21, the electric power required for this is about 0.1 times the base supply power. Therefore, the converter 29 of the electric power supply device 11 is not required to have a large conversion capacity, is reduced in size and weight, and has little influence on the performance of the base body 12.

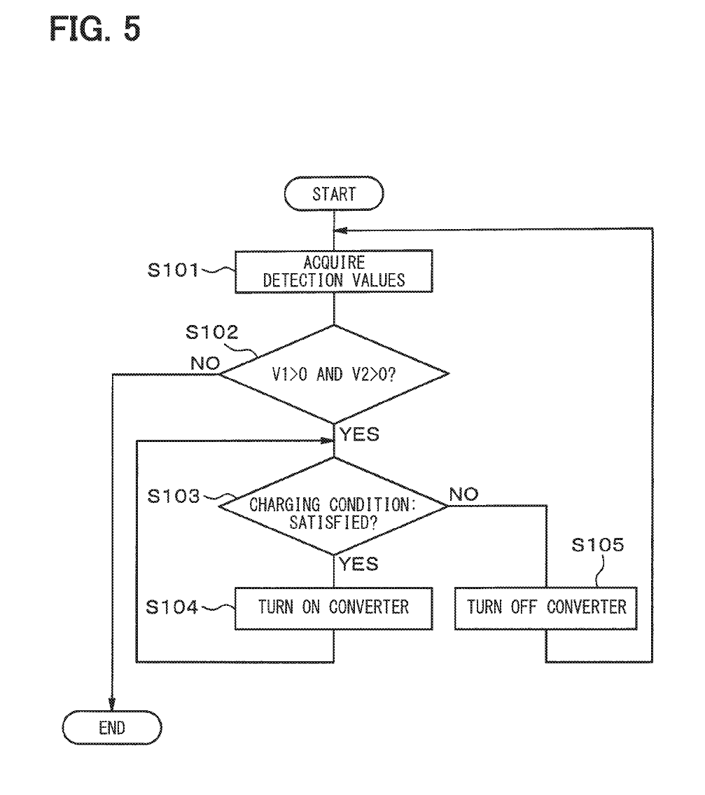

Hereinafter, control processing in the flying machine 10 including the electric power supply device 11 configured as described above will be described with reference to FIG. 5.

When the electric power supply of the flying machine 10 is turned on, that is, when the electric power supply from the electric power supply device 11 to the base body 12 is started, the control unit 28 acquires first and second detection values of the first power supply unit 21 and the second power supply unit 22, respectively (S101). Specifically, the detection unit 25 detects at least one of the voltage and the current of electric power supplied from the first power supply unit 21 as the first detection value, and the detection unit 26 detects at least one of the voltage and the current of electric power supplied from the second power supply unit 22 as the second detection value. In the first embodiment, the detection unit 25 detects the voltage of the first power supply unit 21 as a first voltage detection value V1, and detects the current supplied from the first power supply unit 21 as a first current detection value I1. Similarly, the detection unit 26 detects the voltage of the second power supply unit 22 as a second voltage detection value V2, and detects the current supplied from the second power supply unit 22 as a second current detection value 12.

The control unit 28 checks whether both the detection value V1 and the detection value V2 are higher than zero (S102). That is, the control unit 28 checks whether or not the first power supply unit 21 and the second power supply unit 22 are in a state capable of supplying electric power to the thruster 13. When either one of the detection value V1 or the detection value V2 is zero (S102: NO), the control unit 28 finishes the processing. That is, when either one of the detection value V1 or the detection value V2 is zero, either one of the first power supply unit 21 and the second power supply unit 22 cannot supply the electric power to the base body 12. Therefore, the control unit 28 finishes the processing and disables the base body 12 to fly.

When both the detection value V1 and the detection value V2 are higher than 0 (S102: YES), the control unit 28 checks whether or not the charging condition is satisfied (S103). That is, the control unit 28 checks whether the detection value V2 is higher than the detection value V1 detected in S101 as a charging condition, the detection value V1 is lower than a preset voltage Vr and the detection value I1 is zero. That is, the control unit 28 checks whether or not all of required conditions, that is, V1<V2, V1<Vr and I1=0, are satisfied as the charging condition. In case of charging the first power supply unit 21 with the electric power supplied from the second power supply unit 22, the voltage of the second power supply unit 22 must be higher than the voltage of the first power supply unit 21. Therefore, the control unit 28 requires that the detection value V2 is higher than the detection value V1 as the charging condition. When the voltage of the first power supply unit 21 is too high, the first power supply unit 21 cannot be charged with the electric power of the second power supply unit 22. Therefore, the control unit 28 requires that the detection value V1 is lower than the preset voltage Vr as the charging condition. The preset voltage Vr may be arbitrarily set according to the performance of the first power supply unit 21 and the second power supply unit 22. Furthermore, when the first power supply unit 21 is supplying electric power to the base body 12, it is not possible to charge the first power supply unit 21. Therefore, the control unit 28 requires that the detection value I1 is zero as the charging condition.

When all these charging conditions are satisfied (S103: YES), the control unit 28 turns on the converter 29 (S104). Thus, the first power supply unit 21 is charged with the electric power generated by the second power supply unit 22. The control unit 28 returns its processing to S103 and repeats the processing from S103 onward. On the other hand, when any one of the charging conditions in S103 is not satisfied (S103: NO), the controller 28 turns off the converter 29 (S105). That is, when the charging condition is not satisfied, the first power supply unit 21 cannot be charged. Therefore, the control unit 28 turns off the converter 29 and cuts off the supply of electric power from the second power supply unit 22 to the first power supply unit 21. Then, the control unit 28 returns its processing to S101, and repeats the processing from S101. The control unit 28 repeats the above-described processing until the electric power of the flying machine 10 is turned off.

As described above, in the first embodiment, the electric power control unit 27 controls the electric power transmission between the first power supply unit 21 and the second power supply unit 22 based on the detection value V1, the detection value V2 and the detection value I1 detected by the detection unit 25 and the detection unit 26. When the voltage of the first power supply unit 21 among the multiple power supply units drops, the electric power control unit 27 turns on the converter 29 and supplies electric power from the second power supply unit 22 to the first power supply unit 21. As a result, the first power supply unit 21 whose supply capacity is lowered is charged by electric power supplied from the second power supply unit 22. As a result, even in case that the electric power capacity of the first power supply unit 21 is small, the first power supply unit 21 is charged by the second power supply unit 22 having a large supply margin. Therefore, stable electric power supply can be achieved for a long period.

Further, in the first embodiment, the flying machine 10 includes the electric power supply device 11. Therefore, the base body 12 is enabled to extend the flight time with the electric power supplied from the electric power supply device 11 stably for a long period of time. The base body 12 requires instantaneous large electric power when it need be controlled with high responsiveness for flying at high speeds or countering to disturbance such as wind. Except for such cases as high-speed flight control and anti-disturbance flight control, the base body 12 can maintain flight with the electric power supply from a base power supply unit like the second power supply unit 22 having the fuel cell. In addition, the second power supply unit 22 for maintaining the flight of the base body 12 has sufficient margin in electric power supply. Therefore, when the flying machine 10 is flying only with the base supply power, for example, during hovering, the second power supply unit 22 can supply electric power to the first power supply unit 21 which is required to supply electric power instantaneously. The electric power control unit 27 charges the first power supply unit 21 with the electric power of the second power supply unit 22 when the base body 12 is flying only with the base supply power supplied from the second power supply unit 22. As a result, even when the electric power capacity of the first power supply unit 21 required to supply the instantaneous electric power is small, the first power supply unit 21 can maintain its electric power supply owing to charging by the second power supply unit 22 as long as the second power supply unit 22 is capable of supplying electric power. Therefore, stable flight can be achieved continuously for a long period.

In the first embodiment, the second power supply unit 22 supplies electric power for charging the first power supply unit 21 when the electric power consumed by the base body 12 is small, such as during hovering. Therefore, it is sufficient that the second power supply unit 22 has an electric power generation capacity of, for example, about 1.1 times the base supply power. By setting the electric power generation capacity of the second power supply unit 22 to about 1.1 times the base supply power, the second power supply unit 22 need not be sized large nor weighted heavier. In addition, when the second power supply unit 22 charges the first power supply unit 21, the electric power required for this charging is about 0.1 times the base supply power. Therefore, the converter 29 of the electric power supply device 11 is not required to have a large conversion capacity, and the size and weight can be reduced. Therefore, it is possible to continuously achieve the stable flight for a long period while reducing the influence on the performance of the base body 12.

### Second Embodiment

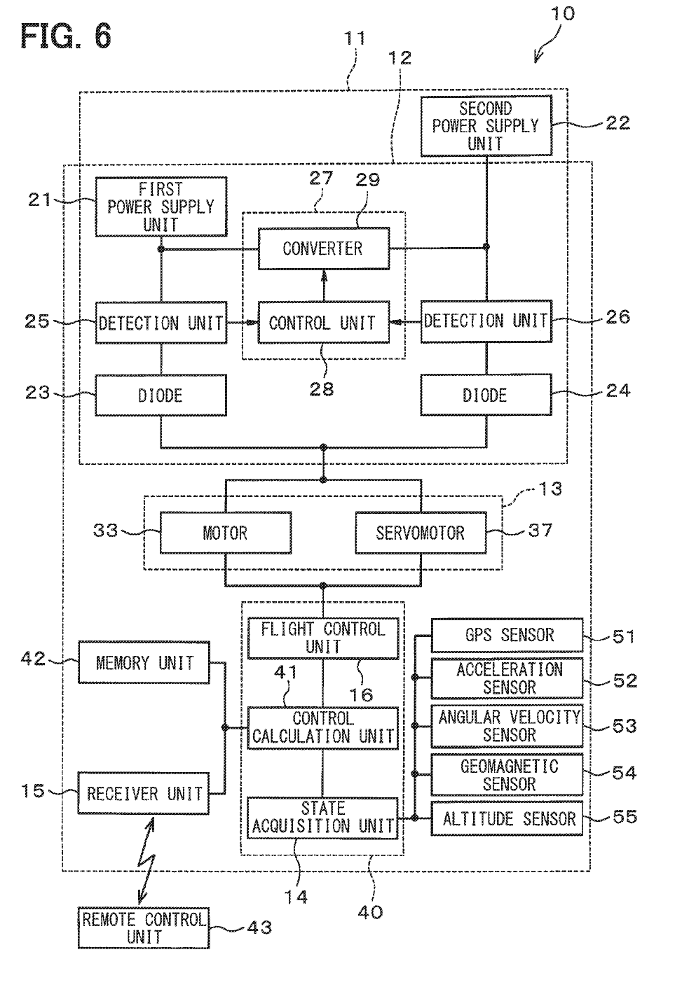

A flying machine including an electric power supply device according to a second embodiment will be described next. As shown in FIG. 6, in the flying machine 10 according to the second embodiment, the second power supply unit 22 is provided on the ground. That is, the second power supply unit 22 is not mounted on the base body 12 but is provided on a ground facility which is separated and away from the based body 12. The second power supply unit 22 and the base body 12 are electrically connected by a wire. In this case, the second power supply unit 22 is not limited to a machine-mounted power supply unit such as a fuel cell but may be a commercial electric power supply or the like. On the other hand, the first power supply unit 21 for supplying instantaneous electric power is mounted on the base body 12 as in the first embodiment.

In the second embodiment, by using the electric power supply on the ground, the base body 12 is enabled to fly for a long time without substantial limitation to the flight period. Further, in the second embodiment, it is unnecessary for the base body 12 to mount the second power supply unit 22 having a relatively large weight thereon. Therefore, it is possible to achieve many advantages such as improvement in mobility of the base body 12 due to weight reduction, increase in payload, size reduction and the like.

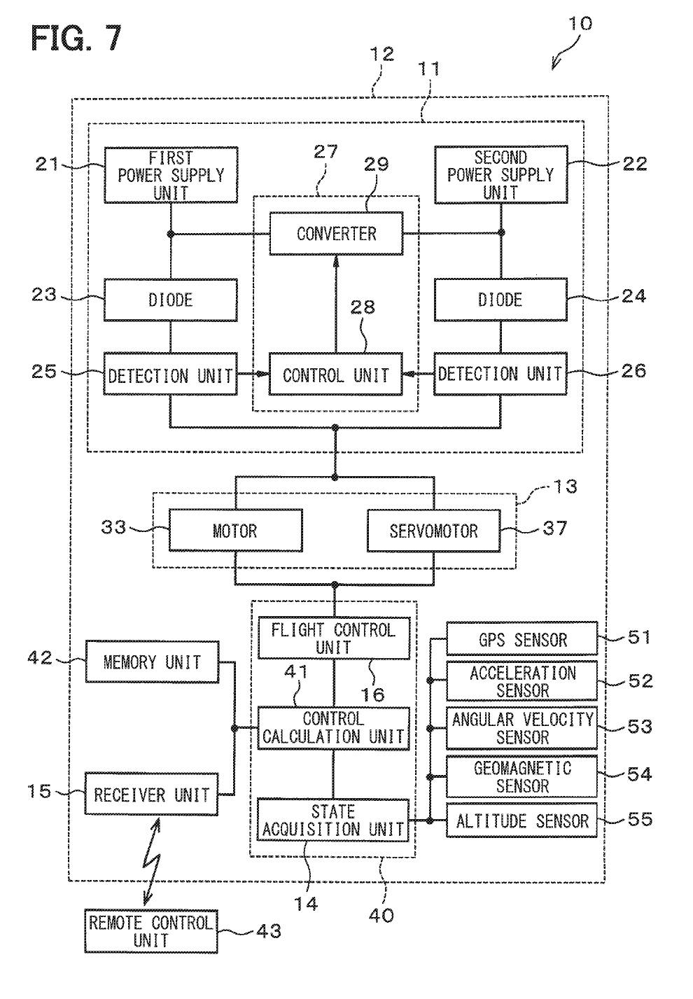

The present disclosure is not limited to the embodiments described above but may be modified in various ways without departing from the spirit of the disclosure. For example, as shown in FIG. 7, the detectors 25 and 26 may be connected to be closer to the thruster 13 of the base body 12 than the diodes 23 and 24. In addition, in the embodiments described above, the electric power supply device 11 is exemplified as including two electric power sources, that is, the first power supply unit 21 and the second power supply unit 22. However, the electric power supply device 11 may have three or more power supply units. Furthermore, in the embodiments described above, the electric power control unit 27 is exemplified as controlling the converter 29 by software by the control unit 28. However, the electric power control unit 27 may be configured to control the transmission of electric power between the first power supply unit 21 and the second power supply unit 22 by hardware, or by cooperation of software and hardware.

Although the present disclosure has been described in accordance with the embodiments, it is understood that the present disclosure is not limited to the embodiments and structures disclosed therein. The present disclosure covers various modification examples and equivalent arrangements. Furthermore, various combination and formation, and other combination and formation including one, more than one or less than one element may be made in the present disclosure.

What is claimed is:

1. An electric power supply device comprising:
multiple power supply units for supplying electric power to a load which consumes electric power;
diodes provided for the multiple power supply units for preventing electric power from being transmitted to the multiple power supply units reversely, respectively;
detection units provided between the multiple power supply units and the load, respectively, for detecting at least one of a current and a voltage; and
an electric power control unit for controlling transmission of electric power among the multiple power supply units based on detection values of the detection units.

2. The electric power supply device according to claim 1, wherein:
the multiple electric power supply devices include at least one electric power generator and at least one secondary battery.

3. The electric power supply device according to claim 2, wherein:
the electric power generator is a fuel cell.

4. The electric power supply device according to claim 2, wherein:
the electric power generator is an engine-generator.

5. A flying machine comprising:
the electric power supply device according to claim 1;
a base body on which at least one of the multiple power supply units is mounted;
a thruster including multiple thruster members provided on the base body for generating thrust force with the electric power supplied from the electric power supply device;
a state acquisition unit for acquiring a flight state of the base body;
a receiver unit for receiving a signal which is transmitted to the base body; and
a flight control unit for controlling a flight of the base body by controlling the thrust force of the thruster based on at least one of the flight state acquired by the state acquisition unit and the signal received by the receiver unit.

6. The flying machine according to claim 5, wherein:
at least one of the multiple power supply units of the electric power supply device is provided separately from the base body and electrically connected to the base body.

7. A flying machine comprising:
a base body;
an electric power supply device including at least a secondary battery, which is provided on the base body, and a power generator;
a thruster provided on the base body for generating thrust force with electric power supplied from the electric power supply device;
a state acquisition unit for acquiring a flight state of the base body; and
a flight control unit for controlling a flight of the base body by controlling the thrust force of the thruster based on the flight state acquired by the state acquisition unit,
wherein the electric power supply device further includes a power control unit for controlling the electric power supplied from the electric power supply device to the thruster,
the power control unit includes a converter, which is turned on to charges the secondary battery by the power generator when a charging condition is satisfied, the charging condition being that a voltage of the power generator is higher than that of the secondary battery, a voltage of the secondary battery is lower than a present voltage and a current supplied from the secondary battery to the thruster is zero.

8. The flying machine according to claim 7, wherein:
the power generator is set to have a power generation capacity which is substantially 1.1 times a power required for the thruster to fly the base body stably.
